(19) United States
(12) Patent Application Publication
(10) Pub. No.: US 2010/0089527 A1
(43) Pub. Date: Apr. 15, 2010

(54) METHOD OF PREPARING A SYNTHETIC RESINOUS ARTICLE ON WHICH NATURAL WOOD-BASED PANELS ARE FORMED

(76) Inventors: Goo-Soon Lee, Daegu (KR); Seung-Jun Kim, Daegu (KR)

Correspondence Address: LOWE HAUPTMAN HAM & BERNER, LLP, 1700 DIAGONAL ROAD, SUITE 300, ALEXANDRIA, VA, 22314, US

(21) Appl. No.: 12/530,748

(22) PCT Filed: May 23, 2007
(86) PCT No.: PCT/KR07/02490

§ 371 Date: Sep. 10, 2009

(30) Foreign Application Priority Data
Mar. 14, 2007 (KR) 10-2007-0025226
May 4, 2007 (KR) 10-2007-0043596

(51) Int. Cl. B29C 45/00; B44C 3/08; B32B 38/04; B29C 65/00

(52) U.S. Cl. 156/245; 156/219; 156/256

(57) ABSTRACT

Disclosed is a method of preparing a synthetic resinous article on which natural wood-based panels are formed, comprising: preparing a thin panel from a natural timber and attaching a detachable double-sided adhesive tape to outer sides thereof, thereby preventing and stabilizing the natural wood-based panel from being divided or fractured along wood grains; making a micro-hole or embossed groove on the surface of the thin panel to form a bonding surface; and then bonding a thermoplastic synthetic resin to the wood-based panel to be united each other, such that the natural wood-based panels can be attached to the surface of the article to be intended to obtain.

### TECHNICAL FIELD

The present invention relates to a method of preparing a synthetic resinous article on which natural wood-based panels are formed, comprising: preparing a thin panel from a natural timber and attaching a detachable double-sided adhesive tape to outer sides thereof, thereby preventing and stabilizing the natural wood-based panel from being divided or fractured along wood grains; making a micro-hole or embossed groove on the surface of the thin panel to form a bonding surface; and then bonding a thermoplastic synthetic resin to the wood-based panel to be united each other, such that the natural wood-based panels can be attached to the surface of the article to be intended to obtain.

### BACKGROUND ART

A conventional natural wood-based article has disadvantages as below. It has been commonly made from a natural wood into a panel, and preparing a case or a housing body of the article using an adhesive and a coupling tool, or made from sawing and trimming the natural wood to prepare an article at regular shape. However, since there have been no methods of preparing a thin wood panel to bond it to a surface of the synthetic resinous article, the natural wood-based panel can not be attached to the case of synthetic resinous portable article, such as a cellular phone, a mp3, a recorder, a radio, a watch, and a writing tool. Although there has been a method of adhering a patterned wood to a surface of the article in order to express a wood grain and a texture of the natural wood, it has disadvantages in that the wood grain can not be attached to a rounded portion, it is weak in durability due to the defects in easy separation of a adhering portion of the patterned wood, and it degrades a productivity due to the decrease of work efficiency.

### DISCLOSURE

### Technical Problem

The present invention is designed in consideration of the above disadvantages, and therefore it is an object of the invention to provide a method of preparing an article, capable of providing the article with a texture feeling such as a natural wood by bonding the natural wood to a synthetic resin.

### Technical Solution

Accordingly, it is an object of this invention, which overcomes the above disadvantages, to provide a method of preparing a synthetic resinous article on which natural wood-based panels are formed, comprising: preparing a thin panel from a natural timber and attaching a detachable double-sided adhesive tape to outer sides thereof, thereby preventing and stabilizing the natural wood-based panel from being divided or fractured along wood grains; making a micro-hole or embossed groove on the surface of the thin panel to form a bonding surface; and then bonding a thermoplastic synthetic resin to the wood-based panel to be united each other, such that the natural wood-based panels can be attached to the surface of the article to be intended to obtain.

### Advantageous Effects

The present invention provides a lot of advantages in that a natural wood can be readily bonded with a synthetic resin due to the thinner sawing of the natural wood in a thickness of about 0.2 to about 1.0 mm; can be stabilized by attaching a double-sided adhesive tape (2) to one side thereof to prevent the thin panel from dividing or fracturing along the wood grains of tree rings, thereby capable of maintaining a shape required in the step of drilling thereof or bonding of the synthetic resin, and preventing deformation thereof; can be readily mounted when the thin wood-based panel is attached into an injection mold or is laminated on a conveyor for coating by using the double-sided adhesive tape in stabilizing the wood, thereby capable of improving a workability; can be protected in processing due to the separation property of the double-sided tape after forming; and since the wood-based panel has micro-holes or embossed holes, the synthetic resin permeates into the wood-based panel in bonding with the panel, such that it is possible to prevent a relax of the wood-based panel and the synthetic resin, and no need to use another adhesive.

In addition, the present invention provides other advantages as described hereinbelow. The synthetic resin is bonded to a bonding surface of the wood-based panel to form panels, such that it can form a second molding, thereby capable of forming a rounded article by means of hot-pressing molding machine (41). Thereby, this invention can be fabricated in the form that natural wood grains are formed on the surface thereof in, for example, such as embedded component in a vehicle, an aircraft or a ship, a knob of kitchen article, a case of various article such as a case of cellular phone, a stationery, a cosmetic case, a miniaturized accessory, and the like. This invention can be utilized in fabricating an article that the shape and texture of that surface is the same as that of natural tree.

Further, since, when the case is molded, the wood-based panel is formed to be attached to the surface of the case, followed by machining the inner surface or forming therein a bonding device, such as bolt, nut, hook threshold, by means of an insert molding, a complete manufacture of the article can be easily performed. Due to the development of materials of this invention, the textures and esthetics of natural wood can be provided with its attaching on the surface of the article to an embedded component of a vehicle, an aircraft or a ship, and a component of kitchen applications as well as an electronic article, such as a TV or a radio, a cellular phone, a recorder, a mp3, a stationery, a writing tool, a watch, a palm mirror, a case of cosmetics, a baby application, and an accessory, regardless of a planar article or a rounded article.

### DESCRIPTION OF DRAWINGS

This invention will be described in detail with reference to the accompanying drawings in which like numerals refer to like elements.

FIG. 1 illustrates a natural wood-based panel of this invention.

FIG. 2 illustrates attaching a double-sided adhesive tape to a wood-based panel of this invention.

FIG. 3 illustrates forming micro-holes in a wood-based panel of this invention.

FIG. 4 illustrates forming embossed grooves in a wood-based panel of this invention.

FIGS. 5 and 6 illustrate an apparatus for injecting and bonding a melted solution of synthetic resin on a wood-based panel of this invention.

FIGS. 7 and 8 illustrate mounting a wood-based panel of this invention into an injection mold to bond it with a melted solution of synthetic resin.

FIG. 9 illustrates a hot-pressing molding machine for molding.

FIG. 10 illustrates bonding a thermoplastic synthetic resinous film to a wood-based panel with a high-frequency heater.

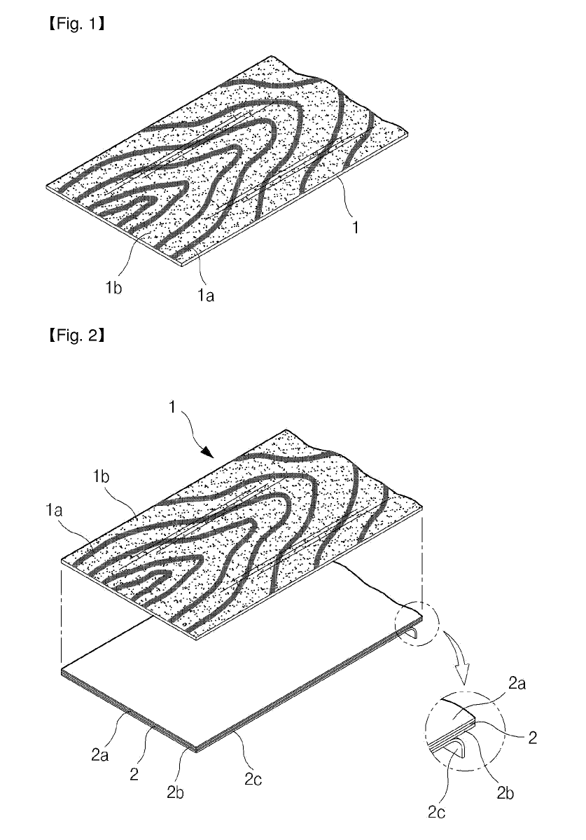

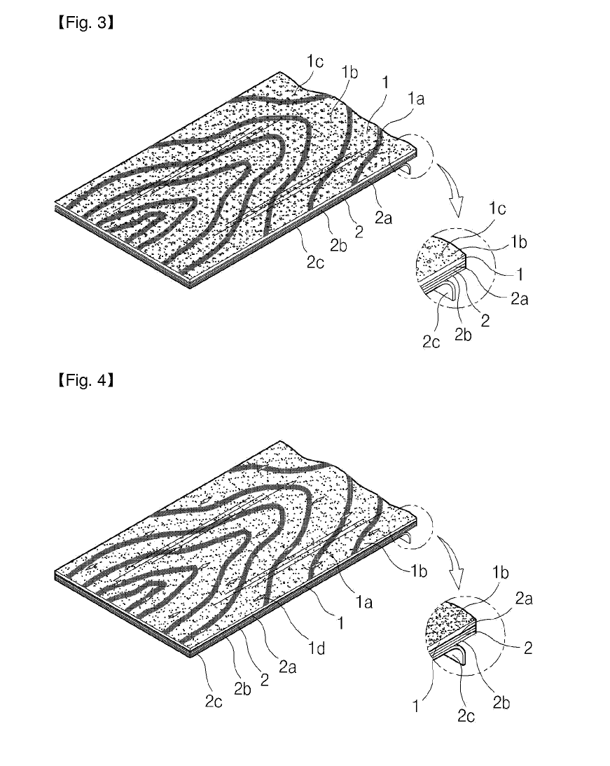

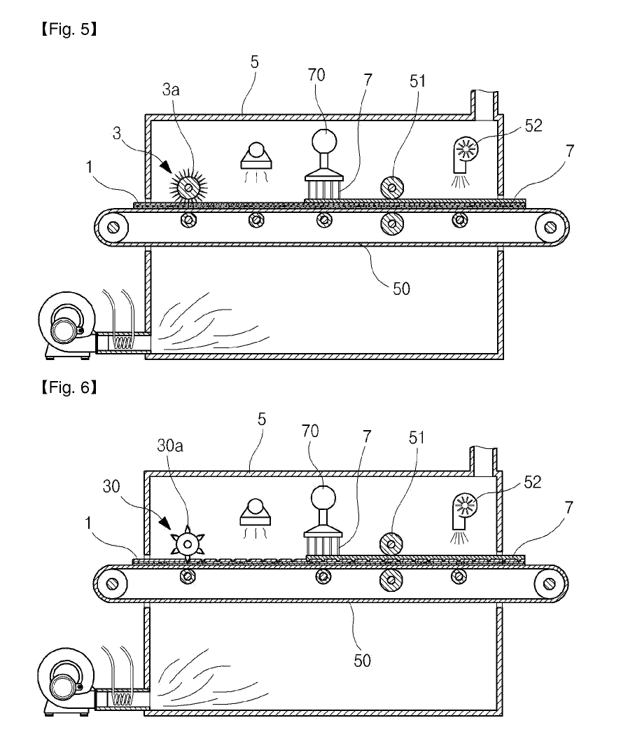

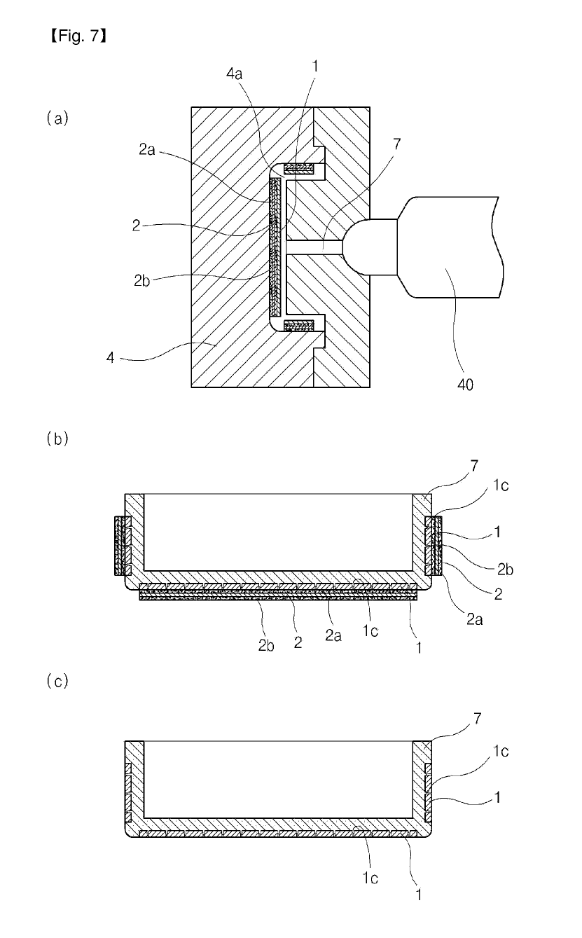

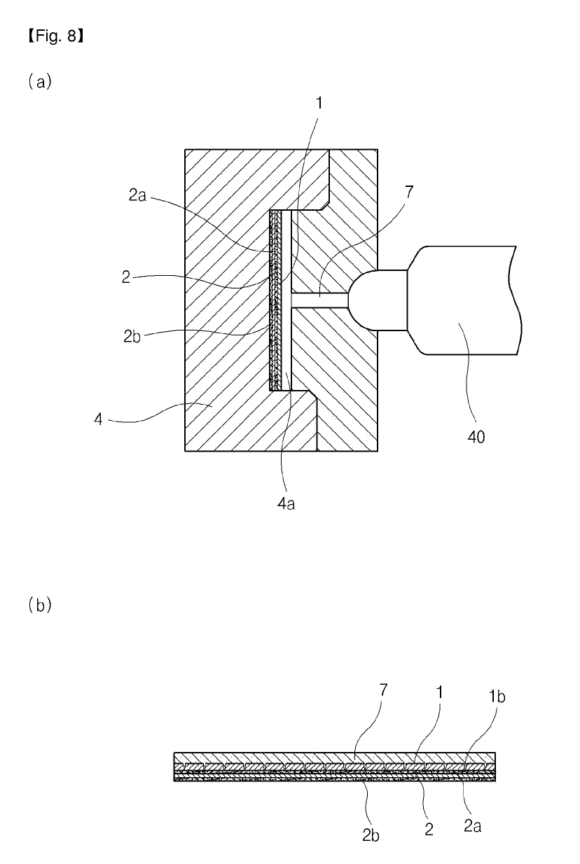

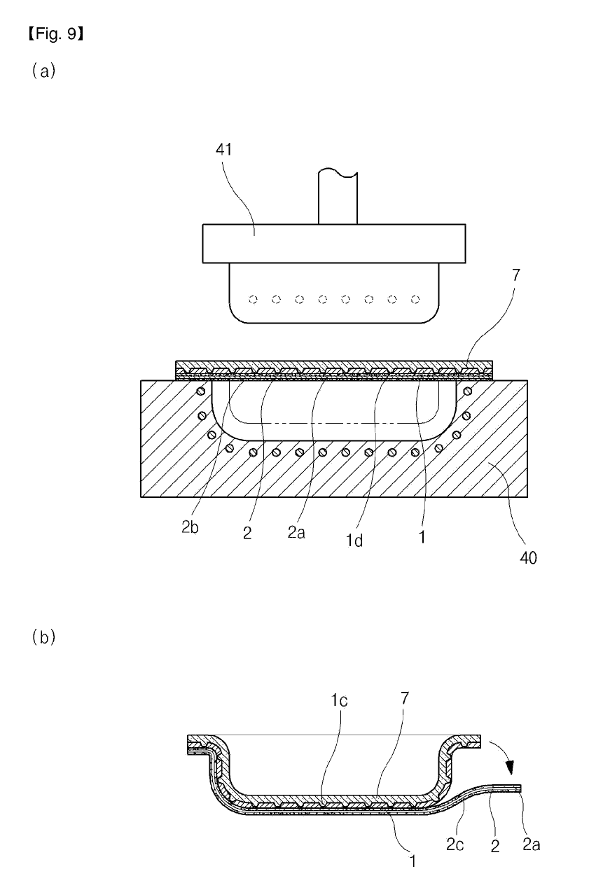

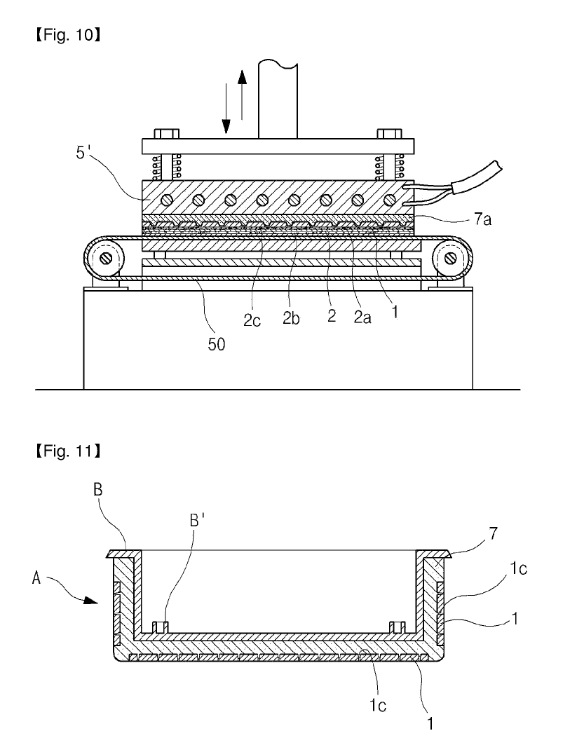

And FIG. 11 illustrates a double-injected article.

### BEST MODE

To fully understand many objects to be accomplished by various embodiments and operational advantages of this invention, preferred embodiments of this invention will be explained with reference to the accompanying drawings.

The present invention concerns a method of preparing a synthetic resinous article on which natural wood-based panels are formed, comprising: preparing a thin panel from a natural timber and attaching a detachable double-sided adhesive tape to outer sides thereof, thereby preventing and stabilizing the natural wood-based panel from being divided or fractured along wood grains; making a micro-hole or embossed groove on the surface of the thin panel to form a bonding surface; and then bonding a thermoplastic synthetic resin to the wood-based panel to be united each other, such that the natural wood-based panels can be attached to the surface of the article to be intended to obtain.

That is, the present invention completes a desired article (A), which comprises the steps of:

sawing a natural timber selected from the group consisting of pine tree, willow tree, Paulownia, teak and rose tree, in a thickness of 0.2 to 1.0 mm, and preparing a thin wood-based panel (1) in which a tree ring portion (1a) with a dense tissue and a tree ring portion (1b) with a soft tissue are formed, cutting the thin wood-based panel (1) at a regular standard, and attaching a heat resistant detachable double-sided adhesive tape (2) comprised of a silicon adhesive and a heat resistant adhesive to outer sides of the cut thin wood-based panel (1), thereby preventing and stabilizing the wood-based panel from being divided or fractured along wood grains (step of preparing a wood-based panel);

contacting the stabilized thin wood-based panel to a puncher (3) with a plurality of spiculations (3a) or a crushing roller (30) with protrusions (30a) to form a micro-hole (1c) or embossed groove (1d), with softening the wood, thereby forming a bonding surface, resulting a good bonding with the synthetic resin (step of forming a bonding surface);

bonding a synthetic resin to the bonding surface of the wood-based panel to be united each other to manufacture an article on which a natural wood-based panel is formed (step of bonding);

and then detaching the double-sided adhesive tape (2) attached to outer sides of the wood-based panel for processing the surface thereof.

Particularly, the step of bonding the synthetic resin to the wood-based panel is carried out by the method of attaching the wood-based panel into a molding space (4a) of an injection mold (4) and performing an injection process of injecting a melted solution of thermoplastic synthetic resin (7) with an injector (40), thereby fixedly attaching the bonding surface of the wood-based panel to the surface of the article molded in the mold (4), or

by the method of attaching the wood-based panel onto a conveyor belt (6) of a processor (5) maintaining a constant temperature to apply a melted solution of a thermoplastic synthetic resin to the bonding surface of the wood-based panel through injection, and then bonding the synthetic resin to the bonding surface of the wood-based panel by means of a crushing roller (51) and a heater (52) and applying a pressure to them with a hot-pressing molding machine (41), thereby attaching the wood-based panel to the surface of the molded article, or

by the method of laminating a thermoplastic synthetic resinous film (7a) on the bonding surface of the wood-based panel, operating a high-frequency gluer (5′) to enable the thermoplastic resinous film (7a) to bond with the bonding surface of the wood-based panel and to enable the wood-based panel to bond with the surface of the molded article, thereby obtaining a synthetic resinous panel bonded with the wood-based panel, putting it into a molding unit of the hot-pressing molding machine (41) and applying a heat and pressure gradually to be intended to form a desired article, thereby fabricating an unitary article in which the natural wood-based panels are bonded with the surface of the synthetic resinous article, and then detaching the adhesive tape attached to the outer surfaces of the wood-based panel for processing the surface thereof to obtain a desired article.

On the other hand, the thin wood-based panel of this invention has a soft tissue in its tree rings. Thus, when a lot of micro air-holes are formed therein, there is no need to drill a micro-hole (1c) or form a micro-embossed portion, and thereby enabling to omit the step of forming the bonding surface. The inner and outer adhesive layers (2a) and (2b) of the detachable heat-resistant double-sided adhesive tape (2) can be prepared using a silicon or a composition of silicon resin, preferably a polyethylsiloxane- or polymethylphenylsiloxane-based silicon adhesive. As a sheet, Teflon fiber texture sheet is preferred. Thereby, the detachable double-sided adhesive tape (2), satisfying the heat resistance, can be obtained using them, and the adhesive surface thereof can be protected by attaching a protective lubricant (2c) to the outer surfaces for use.

On the other hand, the thermoplastic synthetic resin, as defined herein, may be a synthetic resin selected from the group consisting of polycarbonate, polyethylene, polypropylene, nylon and ABS resin, and may comprise tourmaline, anti-biotic agent or fragrance incorporated into the synthetic resin.

Moreover, the present invention concerns a method of bonding the natural wood-based panels with the surface of a synthetic resinous article (A) to prepare a united article, followed by inserting thereof into a separate mold to perform a second molding (B) in order to form a bonding means (e.g., protrusion, bolt, nut, hook piece, etc), thereby forming a bonding means (B′) along an inner surface and a periphery of the article.

In addition, many applications and modifications may be made by those skilled in the art within the scope of basic technical spirit of the present invention.

1. A method of preparing a synthetic resinous article on which natural wood-based panels are formed, comprising:
preparing a thin panel from a natural timber and attaching a detachable double-sided adhesive tape to outer sides thereof, thereby preventing and stabilizing the natural wood-based panel from being divided or fractured along wood grains;
making a micro-hole or embossed groove on the surface of the thin panel to form a bonding surface; and then
bonding a thermoplastic synthetic resin to the wood-based panel to be united each other, such that the natural wood-based panels can be attached to the surface of the article to be intended to obtain.

2. A method of preparing a synthetic resinous article on which natural wood-based panels are formed, comprising:
sawing a natural timber selected from the group consisting of pine tree, willow tree, Paulownia, teak and rose tree, in a thickness of 0.2 to 1.0 mm;
preparing a thin wood-based panel (1) in which a tree ring portion (1a) with a dense tissue and a tree ring portion (1b) with a soft tissue are formed;
cutting the thin wood-based panel (1) at a regular standard;
attaching a heat resistant detachable double-sided adhesive tape (2) comprised of a silicon adhesive and a heat resistant adhesive to outer sides of the cut thin wood-based panel (1), thereby preventing and stabilizing the wood-based panel from being divided or fractured along wood grains;
contacting the stabilized thin wood-based panel to a puncher (3) with a plurality of spiculations (3a) or a crushing roller (30) with protrusions (30a) to form a micro-hole (1c) or embossed groove (1d), with softening the wood, thereby forming a bonding surface;
bonding a synthetic resin to the bonding surface of the wood-based panel to be united each other; and then
detaching the double-sided adhesive tape (2) attached to outer sides of the wood-based panel for processing.

3. The method of preparing a synthetic resinous article on which natural wood-based panels are formed according to claim 2,
wherein the step of bonding the synthetic resin to the wood-based panel is carried out by the method of attaching the wood-based panel into a molding space (4a) of an injection mold (4) and performing an injection process, thereby fixedly attaching the bonding surface of the wood-based panel to the surface of the article molded in the mold (4).

4. The method of preparing a synthetic resinous article on which natural wood-based panels are formed according to claim 2,
wherein the step of bonding the synthetic resin to the wood-based panel is carried out by the method of attaching the wood-based panel onto a conveyor belt (6) of a processor (5) maintaining a constant temperature to apply a melted solution of a thermoplastic synthetic resin to the bonding surface of the wood-based panel through injection, and then bonding the synthetic resin to the bonding surface of the wood-based panel by means of a crushing roller (50) and a heater (51) and applying a pressure to them with a hot-pressing molding machine (41), thereby attaching the wood-based panel to the surface of the molded article.

5. The method of preparing a synthetic resinous article on which natural wood-based panels are formed according to claim 2,
wherein the step of bonding the synthetic resin to the wood-based panel is carried out by the method of laminating a thermoplastic synthetic resinous film (7a) on the bonding surface of the wood-based panel, and then operating a high-frequency gluer (5′) to enable the thermoplastic resinous film (7a) to bond with the bonding surface of the wood-based panel and to enable the wood-based panel to bond with the surface of the molded article.

6. A method of preparing a synthetic resinous article on which natural wood-based panels are formed, comprising: mounting an article (A) on which the natural wood-based panels are attached into a predetermined injection mold, and then performing a second molding (B) in order to form a bonding means (B′) along an inner surface and a periphery of the article.
